(19) United States
(12) Patent Application Publication
(10) Pub. No.: US 2013/0048500 A1
(43) Pub. Date: Feb. 28, 2013

(54) TITANIUM AND TITANIUM ALLOY CARBON COMPOSITES FOR CAPACITIVE WATER PURIFICATION AND OTHER APPLICATIONS

(71) Applicants: Craig A. Blue, Knoxville, TN (US); Sheng Dai, Knoxville, TN (US); David W. DePaoli, Knoxville, TN (US); James O. Kiggans, JR., Oak Ridge, TN (US); Richard T. Mayes, Knoxville, TN (US); William H. Peter, Knoxville, TN (US); Constantinos Tsouris, Oak Ridge, TN (US)

(72) Inventors: Craig A. Blue, Knoxville, TN (US); Sheng Dai, Knoxville, TN (US); David W. DePaoli, Knoxville, TN (US); James O. Kiggans, JR., Oak Ridge, TN (US); Richard T. Mayes, Knoxville, TN (US); William H. Peter, Knoxville, TN (US); Constantinos Tsouris, Oak Ridge, TN (US)

(73) Assignee: UT-BATTELLE, LLC, Oak Ridge, TN (US)

(21) Appl. No.: 13/219,034

(22) Filed: Aug. 26, 2011

(51) Int. Cl. C02F 1/48; B03C 5/02; C04B 35/64

(52) U.S. Cl. 204/554; 264/642; 264/604; 204/674

(57) ABSTRACT

A method of forming a carbon and titanium containing composite that includes mixing a titanium-containing powder with carbon and forming the mixture of the titanium-containing-powder and carbon into a composite structure at a temperature of less than 1500° C. The forming process provides a net shape having dimensions within 90% or greater than the final shape of the product. The binder of the composite is provided by the titanium, and the dispersed phase of the composite is provided by the carbon. The carbon and titanium containing composite may be employed as in applications including capacitive deionization (CDI), gas separation, chromatography, catalysis and electrode.

This invention was made with government support under Contract Number DE-AC05-000R22725 between the United States Department of Energy and UT-Battelle, LLC. The U.S. government has certain rights in this invention.

### BACKGROUND

Titanium has been employed in applications for automotive, defense, aerospace, and biomedical fields. Titanium is approximately one half the density of steel while exhibiting the same strength. In comparison to ferrous metals, such as steel, titanium is resistant to corrosion in salt applications making it attractive for heat exchanger applications. The electrical conductivity of titanium is similar to other metals, and thus can act as a conductor. Many of the industrial parts made up to this point have been made from melt products that are then machined into shapes.

### SUMMARY

In one aspect, the present disclosure provides a method of forming a composite material of titanium and/or titanium alloys with carbon. In one embodiment, the method includes mixing a titanium-containing powder with carbon and forming the mixture of the titanium-containing powder and carbon into a composite structure at a temperature of less than 1500° C. The forming process provides a net shape having dimensions within 90% or greater than the final shape of the product. The binder of the composite is provided by the titanium-containing powder, and the dispersed phase of the composite is provided by the carbon. The composite material may be useful for a variety of applications, particularly as capacitive deionization (CDI) electrode materials. Other applications include, for example, gas separation, chromatography, catalysis (e.g., as a support or active material), electrode materials (e.g., in batteries), and supercapacitors.

In one embodiment, a device for capacitive deionization is provided that includes at least two porous electrodes, wherein each of the two porous electrodes is comprised of a carbon and titanium composite. The carbon provides the dispersed phase of the composite and the titanium provides the matrix phase of the composite. The two porous electrodes are spaced in a manner so that liquid (typically water, or an aqueous solution containing water) makes contact with the electrodes. In some embodiments, the electrodes are separated by an insulating material that permits the flow therethrough of water to be deionized by inclusion of flow channels in the insulating material. The insulating material includes passages, such as spaces, channels, or pores, that permit the liquid to make contact with the porous electrodes.

In another embodiment, a method of capacitive deionization is provided. The method of capacitive deionization may begin with providing at least two porous electrodes, wherein each of the two porous electrodes is comprised of a carbon and titanium composite. The carbon provides the dispersed phase of the composite and the titanium provides the matrix phase of the composite. The at least two porous electrodes are spaced to provide a passageway for an electrolyte stream to make contact with each of the two porous electrodes. The electrolyte stream is passed through the passageway into contact with the two porous electrodes while a bias is applied across the two porous electrodes. Cations and anions within the electrolyte stream are attracted to an oppositely charged surface of the two porous electrodes, wherein the cations and anions are removed from the electrolyte stream by adsorption to the oppositely charged surface of the two porous electrodes.

### BRIEF DESCRIPTION OF THE DRAWINGS

The following detailed description, given by way of example and not intended to limit the disclosure solely thereto, will best be appreciated in conjunction with the accompanying drawings, wherein like reference numerals denote like elements and parts, in which:

FIG. 1 is a flow diagram depicting one embodiment of forming titanium powder by reducing titanium chloride (TiCl₄) with a continuous loop of liquid sodium (Na), in accordance with the present disclosure.

FIG. 2 is a side-cross sectional view depicting one embodiment of a device for capacitive deionization that includes at least two porous electrodes, wherein each of the two porous electrodes is comprised of a carbon and titanium and/or titanium alloy composite, in accordance with the present disclosure.

FIG. 3 is a photograph depicting a composite of Ti-6Al-4V and activated carbon having a disk geometry, in accordance with one embodiment of the present disclosure.

FIG. 4A is a plot of BET surface characterization of a composite of Ti-6Al-4V and activated carbon wherein the y-axis represents absorption (cm³/g) and the x-axis is the relative pressure (P/P0), in accordance with the present disclosure.

FIG. 4B is a plot of BET surface characterization of a composite of Ti-6Al-4V and activated carbon wherein the y-axis represents absorption (cm³/g) and the x-axis is the relative pressure (P/P0), in accordance with the present disclosure.

FIG. 5 is a plot of the cyclic voltammetry results for a composite of Ti-6Al-4V and activated carbon, in accordance with one embodiment of the present disclosure.

### DETAILED DESCRIPTION

Detailed embodiments of the present disclosure are described herein; however, it is to be understood that the disclosed embodiments are merely illustrative of the compositions, structures and methods of the disclosure that may be embodied in various forms. In addition, each of the examples given in connection with the various embodiments are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the compositions, structures and methods disclosed herein. References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment.

The present disclosure is related to forming composites of carbon and titanium and/or titanium alloys using powder metal technology. “Powder metal technology” is a process of blending powdered materials, pressing them into a desired shape, i.e., compaction, and then heating the compressed material, i.e., sintering. Powder metal processes typically include four steps: (1) powder manufacture, (2) powder mixing and blending, (3) compacting, and (4) sintering. Compacting is typically performed at room temperature, e.g., 20° C. to 25° C., while the elevated temperature process of sintering is usually conducted at atmospheric pressure, e.g., 1 atm. The product resulting from compacting may be referred to as the “green compact”. In the sintering phase of the powder metallurgy manufacturing process, the component and the final powder metal material are formed in a single step. In sintering, the “green compact” parts move into the sintering furnace. The green compact is then heated to below the melting point of the base metal, e.g., titanium and/or titanium alloy, held at the sintering temperature, and then cooled. The melting point of pure titanium is approximately 1725° C. The introduction of alloying elements into titanium may reduce the alloy's melting point when compared to pure aluminum. For example, the melting point of an alloy of titanium, such as Ti₆Al₄V, may range from 1600° C. to 1660° C. Sintering transforms the compacted mechanical bonds between the powder particles into metallurgical bonds. In one embodiment, a composite of titanium and/or titanium alloy with carbon is provided by pressing titanium and/or titanium alloy powder in steel dies into near net shapes that can be sintered. Other processes similar to the above described methods for processing powder metal titanium and/or titanium alloy powders are hot pressing, hot isostatic pressing, and roll forming.

In one embodiment, the present disclosure provides a method of forming a composite structure that includes mixing a titanium-containing powder with a carbon powder. The titanium-containing powder may be unalloyed commercially pure titanium powder or may be a titanium alloy. Examples of unalloyed commercial pure titanium powder may include titanium powder formed from one of the four distinct grades of unalloyed commercially pure titanium, e.g., grade 1, grade 2, grade 3 or grade 4, in accordance with American Society for Testing and Materials (ASTM) F67. For example, the titanium powder may be composed of less than 0.2% iron (Fe), less than 0.18% oxygen (O), less than 0.1% carbon, less than 0.03% nitrogen (N) and less than 0.0125% hydrogen (H) and substantially a remainder of titanium (Ti), in accordance with grade 1 unalloyed commercially pure titanium. In another example, the titanium powder may be composed of less than 0.3% iron (Fe), less than 0.25% oxygen (0), less than 0.1% carbon, less than 0.03% nitrogen (N) and less than 0.0125% hydrogen (H) and substantially a remainder of titanium (Ti), in accordance with grade 2 unalloyed commercially pure titanium. In yet another example, the titanium powder may be composed of less than 0.3% iron (Fe), less than 0.35% oxygen (0), less than 0.1% carbon, less than 0.05% nitrogen (N) and less than 0.0125% hydrogen (H) and substantially a remainder of titanium (Ti), in accordance with grade 3 unalloyed commercially pure titanium. In yet another example, the titanium powder may be less than 0.5% iron (Fe), less than 0.4% oxygen (0), less than 0.1% carbon, less than 0.05% nitrogen (N) and less than 0.0125% hydrogen (H) and substantially a remainder of titanium (Ti). By “substantially a remainder of titanium” it is meant that further incidental impurities may be present in a total concentration of less than 0.1%. In some embodiments, the remainder of the aforementioned powder produced from unalloyed commercially pure titanium is entirely titanium.

In another embodiment, the titanium-containing powder may be comprised of an alloy of titanium, e.g., an alloy of titanium and aluminum. For example, the alloy of titanium that provides the titanium-containing powder may be grade 5 titanium (in accordance with ASTM F67), which may also be referred to as Ti6Al4V, Ti-6Al-4V or Ti 6-4, and has a chemical composition of 6% aluminium (Al), 4% vanadium (V), up to 0.25% iron (Fe), up to 0.2% oxygen and substantially a remainder of titanium (Ti). In another example, Ti6Al4V may include 5.5% to 6.5% aluminum (Al), 3.5% to 4.5% vanadium (V), less than 0.1% carbon, less than 0.3% iron (Fe), less than 0.2% oxygen (O), less than 0.05% nitrogen (N) and less than 0.015% hydrogen (H) and substantially a remainder of titanium (Ti). In other examples, the titanium-containing powder may be any titanium alloy, such as grades 6-35, as defined by ASTM F67.

The titanium-containing powder may have a particle size ranging from 10 microns to 225 microns. The titanium-containing powder may have a particle size ranging from 15 microns to 200 microns. In another example, the titanium-containing powder may have a particle size ranging from 30 microns to 150 microns. In yet another example, the titanium-containing powder has a particle size ranging from 30 microns to 45 microns.

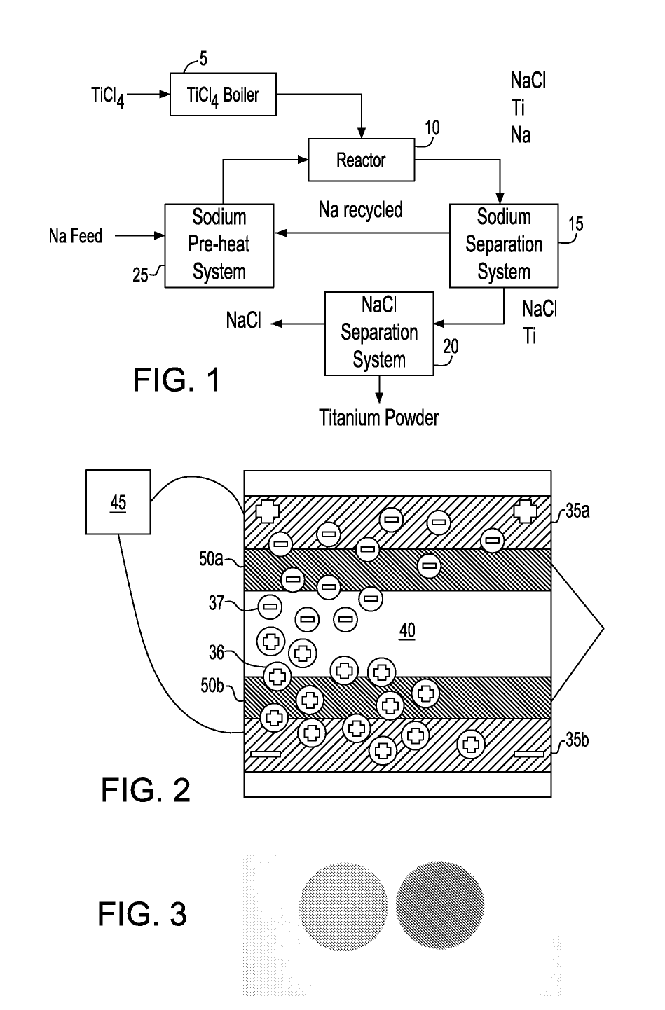

The titanium-containing powder may be formed using any method. For example, the titanium-containing powder may be formed by reduction of titanium chloride (TiCl₄) with liquid sodium (Na). In one embodiment, the titanium-containing powder is formed using a continuous process, in which the liquid sodium (Na) functions as a flowing loop, as depicted in FIG. 1.

Referring to FIG. 1, in one embodiment, titanium chloride (TiCl₄) gas from a TiCl₄ boiler 5 is applied to liquid sodium (Na) in a reactor 10. Controlled continuous injection of titanium chloride (TiCl₄) gas into the liquid sodium (Na) in the reactor 10 produces particles of titanium (Ti) and sodium chloride (NaCl). The temperature in the reactor 10 typically ranges from 200° C. to 600° C. Following the reactor 10, the surrounding sodium (Na) stream, i.e., liquid sodium (Na), carries the reaction products from the reaction between the titanium chloride (TiCl₄) gas and the liquid sodium (Na), e.g., titanium (Ti) and sodium chloride (NaCl), into a sodium separation system 15. At this stage, the solid titanium (Ti) and sodium chloride (NaCl) may be filtered from the liquid sodium (Na). The solid titanium (Ti) and sodium chloride (NaCl) may be filtered from the liquid sodium (Na) using at least one of cyclones, particulate filters, magnetic separators or vacuum stills.

The flowing loop of liquid sodium (Na) continues to the sodium pre-heat system 25. At this point, additional sodium (Na) may be added to the process to rejuvenate the loop of liquid sodium (Na) and the temperature of the liquid sodium (Na) may be adjusted. The additional sodium (Na) may be sodium that is recycled from the process.

When sufficient material, i.e., solid titanium (Ti) and sodium chloride (NaCl) accumulates at the sodium separation system 15, the flow is switched to a sodium chloride (NaCl) separation system 20 without interrupting the flow of the liquid sodium (Na). At the sodium chloride (NaCl) separation system 20, the residual sodium (Na) is distilled from the filtrate and the titanium (Ti) powder is removed and washed to remove any salt, e.g., sodium chloride (NaCl). In one embodiment, the titanium (Ti) powder is washed with a water and/or alcohol wash. The titanium powder (Ti) may satisfy the requirements for commercially pure titanium in accordance with Grades 1-4 of ASTM F67, as described above.

The salt, e.g., sodium chloride (NaCl), is typically the only byproduct of the process flow that is depicted in FIG. 1. In some instances, the sodium chloride (NaCl) can be broken down electrolytically into sodium (Na) and chlorine (Cl), which can be recycled into the process. In some embodiments, aluminum (Al) and vanadium (V) may be introduced to the titanium being produced by mixing aluminum-containing gasses, such as aluminum chloride (AlCl₃), and vanadium-containing gasses, such as vanadium (IV) chloride (VCl₄), with titanium chloride (TiCl₄) prior to the reactor 10. In this manner, the titanium produced by the process flow depicted in FIG. 1 may be Ti6Al4V, which may also be referred to grade 5 titanium ( accordance with ASTM F67).

The process flow depicted in FIG. 1 may be referred to as an Armstrong process, which has been provided for illustrative purposes, and is not intended to limit the present disclosure solely thereto. The titanium powder used in the disclosed method may be formed using any process, including the Krull or Hunter processes. The Hunter process employs sodium (Na) to reduce titanium chloride (TiCl₄) in the production of titanium powder. The Hunter process produces titanium powder in a manner that is chemically similar to the process flow depicted in FIG. 1, but is differentiated from the continuous process flow depicted in FIG. 1, because the Hunter process for forming titanium powder is a batch process.

In the Krull process, titanium chloride (TiCl₄) is chemically reduced by magnesium (Mg) at 900° C. to 1100° C. Similar to the Hunter process, the Krull process is a batch process. For example, the reduction of titanium chloride (TiCl₄) with magnesium (Mg) may be conducted in a metal retort with an inert atmosphere, such as helium (He) or argon (Ar). More specifically, magnesium (Mg) is charged into the vessel and heated to produce a molten magnesium (Mg) bath. Liquid titanium tetrachloride (TiCl₄) is then dispersed dropwise above the molten magnesium (Mg) bath, wherein the liquid titanium tetrachloride (TiCl₄) vaporizes in the gaseous zone above the molten magnesium (Mg) bath. A reaction occurs on the molten magnesium (Mg) surface to form titanium (Ti) and magnesium chloride (MgCl).

The titanium (Ti) fuses into a mass that encapsulates some of the molten magnesium chloride (MgCl). This fused mass is called titanium (Ti) sponge. After cooling of the metal retort, the solidified titanium (Ti) sponge metal is broken up, crushed, purified and then dried in a stream of hot nitrogen (N₂). Powder titanium (Ti) is usually produced from the sponge through grinding, shot casting or centrifugal processes. One technique is to first react the titanium (Ti) with hydrogen (H) to make brittle titanium hydride (TiH₂) to facilitate the grinding process. After formation of the powder titanium hydride (TiH₂), the particles are dehydrogenated to produce a usable metal powder product.

The above titanium-containing powder is mixed with carbon powder, and subjected to a metal powder manufacturing process to form a composite structure. A composite structure is a material composed of two or more distinct phases, e.g., matrix phase and dispersed phase, and having bulk properties significantly different from those of any of the constituents, i.e., the titanium and carbon, by themselves. As used herein, the term “matrix phase” denotes the phase of the composite that is present in a majority of the composite and contains the dispersed phase and shares a load with it. The matrix phase may be the binder of the composite structure. In the present case, the matrix phase may be provided by the titanium powder. A used herein, the term “dispersed phase” denotes a second phase (or phases) that is embedded in the matrix phase. In the present case, the dispersed phase is provided by carbon and may provide the absorption site for capacitive water purification or gas absorption. It is noted that water purification and gas absorption are only two applications for the composite structure formed by the present disclosure. The composite disclosure disclosed herein is applicable to any structure in which carbon provides the functionality of the structure.

The carbon powder may be made by heating powdered petroleum coke above the temperature of graphitization. The carbon may be activated carbon, mesoporous carboy and/or activated mesoporous carbon. As used herein, “activated carbon” is carbon that has been treated with oxygen to provide a highly porous material having a surface area ranging from 300 m²/g to 3,000 m²/g. In one embodiment, the surface area of the activated carbon may from 1000 m²/g to 2,000 m²/g. The porosity provides the activated carbon with a surface area that allows for liquids or gases to pass through the activated carbon and interact with the exposed carbon. Activated carbon has found use in various applications, such as, air and water purification, hydrocarbon absorption in automotive evaporative emission control, and cold start hydrocarbon adsorption, etc.

“Mesoporous carbon”, as used herein, is carbon containing pores with diameters between 2 nm and 50 nm. In one embodiment, the mesoporous carbon may have a diameter ranging from 10 nm to 40 nm. In yet another embodiment, the mesoporous carbon has a diameter ranging from 15 nm to 35 nm. Activated mesoporous carbon, is carbon that is both activated as described above, and has a pore size distribution consistent with the meaning of mesoporous carbon.

It is noted that the carbon may also be microporous carbon or macroporous carbon, or may be a combination of microporous, mesoporous and macroporous carbon. Microporous carbon has a pore size with diameters of less than 2 nm. For example, microporous carbon as used in accordance with the present disclosure may have pores with a diameter ranging from 5 Å to 15 Å. Macroporous carbon has a diameter greater than 50 nm. For example, macroporous carbon may have pores with a diameter ranging from 50 nm to 100 nm.

The carbon powder may have a particle size with a diameter ranging from 5 nm to 1000 μm. In another embodiment, the carbon powder may have a particle size ranging from 50 nm to 500 μm. In yet another embodiment, the carbon powder may have a particle size ranging from 50 μm to 100 μm.

The titanium-containing powder and carbon powder are then blended. In one embodiment, the homogeneous mass of titanium-containing powder and carbon powder are blended to provide a homogeneous mass. Blending of the titanium-containing powder and the carbon powder may include a sieve process, in which the particle size of the powder is characterized and controlled. Blending of the titanium-containing powder and the carbon powder may be done in air or may be conducted in an inert atmosphere to reduce oxidation of the powders. The mixing of the blending process may be achieved using any mechanical mixing device, such as a cone or ribbon blender. In some embodiments, a lubricant, such as graphite or stearic acid, may be added to the blended mixture to improve the flow characteristics or compressibility of the mixture. The lubricant may be added in amounts less than 5%.

The constituents within the mixture of the titanium-containing powder and carbon powder may be selected so that the concentration of the carbon in the composite ranges from 5% to 75% of the composite structure, and that the concentration of titanium and/or titanium alloy in the composite ranges from 95% to 25%. In another embodiment, the constituents within the mixture of the titanium-containing powder and carbon powder may be selected so that the concentration of the carbon in the composite ranges from 5% to 50% of the composite structure, and that the concentration of titanium and/or titanium alloy in the composite ranges from 95% to 50%. In yet another example, the constituents within the mixture of the titanium-containing powder and carbon powder may be selected so that the concentration of the carbon in the composite ranges from 40% to 60% of the composite structure, and that the concentration of titanium and/or titanium alloy in the composite ranges from 40% to 60%.

The mixture of the titanium-containing powder and carbon powder is then fowled into the composite structure at a temperature of less than 1500° C. The forming process may be a powder metallurgy process, or a derivative of a powder metallurgy process. Powder metallurgy processes typically include four steps: (1) powder manufacture, (2) powder mixing and blending, (3) compacting, and (4) optional sintering. The steps of power manufacture, and powder mixing and blending have been described above. Compacting and sintering are now described in greater detail.

As used herein, the terms “compacting” and “compaction” denote increasing the density of the mixture of the titanium-containing powder and carbon powder through the application of pressure. Although there are various methods of compaction, each of the methods typically effectuates densification of the titanium-containing powder and carbon powder in the same manner. Specifically, in one embodiment, beginning with the initial arrangement of the individual particles of the titanium-containing powder and carbon powder, the particles are first repacked into a more efficient manner, followed by deformation of the individual particles with increasing pressure. Repacking of the particles may be via sliding mechanisms, and may also be referred to as an increase in coordination number while maintaining point contact. The deformation of the individual particles in response to increasing pressure may be an elastic or plastic deformation, and may be characterized as a flattening of contact points between adjacent particles, and the creation of new contact points (increased coordination number). The deformed particles may have polyhedron geometry.

In one embodiment, compaction may be provided by powder pressing, which may also be referred to as powder compaction. Powder pressing is a process of compacting powder, e.g., titanium-containing powder and carbon powder, in a die through the application of pressure. Typically powder processing includes a uniaxial compaction process. The geometry of the die typically dictates the geometry of the green product produced by the compaction process. The density of the green product is typically proportional to the pressure being applied. Typical pressures for powder pressing of the titanium-containing powder and carbon powder may range from 10 tons/in² to 50 tons/in². In one embodiment, the pressure for powder pressing of the titanium-containing powder and carbon powder may range from 500 psi to 5,000 psi. Some configuration of die compaction methods suitable for powder pressing include single-action pressing, double-action pressing and floating die pressing. In single-action pressing there is only one moving punch. For example, an upper punch may travel in a vertical line in relation to a stationary base surface of a die. In double-action pressing there are two moving punches that are typically actuated in opposite directions. For example, during compaction the upper punch may be traversed downward, while the opposing lower punch is traversed upward. In floating die pressing, there are two moving punches, but one punch moves during the pressing operation, while a second punch is stationary. Powder pressing is typically conducted at room temperature, e.g., 20° C. to 25° C.

The green product produced by powder pressing may then be sintered. “Sintering” is thermal treatment of the mixture of the titanium-containing powder and carbon powder at a temperature below the melting point of the titanium-containing powder, for the purpose of increasing the green product's strength by bonding together of the particles, i.e., titanium-containing powder and carbon powder. The bonding between adjacent particles of titanium-containing powder is typically metallic bonding. The particles of the carbon powder are typically mechanically bonded by the binder of the composite structure, which is provided by the titanium component of the composite structure. The temperature of the sintering process may be between 60% and 90% of the melting-point of the titanium-containing powder.

In one embodiment, the temperature of the sintering process may range from 750° C. to 1300° C. In another embodiment, the temperature of the sintering process may range from 800° C. to 1000° C. In yet another embodiment, the temperature of the sintering process may range from 850° C. to 950° C.

Sintering can be considered to proceed in three stages. During the first stage, neck growth of the particles of the titanium-containing powder occurs, but the titanium-containing powder particles typically remain discrete. During the second stage, most of the densification of the titanium-containing powders occurs, the structure recrystallizes and particles of the titanium-containing powder diffuse into each other. Carbon is entrapped in the binder of the titanium-containing powder. During the third stage, isolated pores tend to become spheroidal and densification continues. The thermal treatment of the sintering process may conducted in a furnace, such as an electrically heated furnace with graphite or tungsten heating elements.

In some embodiments, the furnace may include three zones, such as a preheat zone, a high temp zone, and a cooling zone. The preheat zone may have a temperature selected to remove lubricants and organics. The high-heat zone is the zone in which the majority of sintering occurs, wherein the temperature may be between 50% and 80% of the melting-point of the titanium-containing powder. The cooling zone reduces the temperature from the high-heat zone, and may be selected to provide a temperature suitable for heat treatment of the sintered product.

The compacting and sintering steps of powder pressing may be repeated to increase density and strength of the composite being formed. In some example, repetition of the compacting step of powder pressing may be referred to as a forging process.

In one embodiment, the compacting and sintering steps of the powder metal process to faun the carbon and titanium and/or titanium alloy containing composite may include vacuum hot pressing. Vacuum hot pressing (VHP) employs a die and pressure to form the composite in a manner that is similar to powder pressing, as described above, but in vacuum hot pressing the compaction step is conducted at an elevated temperature and in a vacuum. Following compacting, a sintering step may not be necessary.

Vacuum hot pressing is a powder compaction method involving uniaxial pressure applied to a controlled amount of powder placed in a die between two rigid rams. Vacuum hot pressing is carried out at elevated temperature and under vacuum or inert gas flow. For example, the vacuum pressure may range from 1.5×10⁻³ Torr to 6×10⁻⁶ Torr. In another example, the vacuum pressure may range from 1.5×10⁻⁴ Ton to 6×10⁻⁵ Torr. The pressure to form the green product during the vacuum hot pressing may range from 0.5 MPa to 60 MPa. In yet another embodiment, the pressure to form the green product during compaction by vacuum hot pressing may range from 0.8 MPa to 55 MPa.

The temperature applied during compaction to foam the green product by vacuum hot pressing may range from 500° C. to 1500° C. Tn another embodiment, the temperature of the sintering process may range from 750° C. to 1250° C. In yet another embodiment, the temperature of the sintering process may range from 900° C. to 1100° C. The simultaneous application of elevated temperature and pressure may provide the compaction and sintering steps of powder metal processing simultaneously. In some embodiments, the high temperature of vacuum hot pressing removes the requirement that the product of the compaction step be further sintered.

In another embodiment, compaction may be provided by isostatic pressing. In isostatic pressing the powder particles, e.g., titanium-containing powder and carbon powder, are placed into a flexible mold and then gas or fluid pressure is applied to the mold. Compacting pressures range from 15,000 psi (100,000 kPa) to 40,000 psi (280,000 kPa). The mold for isostatic pressing are available in three styles, free mold (wet-bag), coarse mold(damp-bag), and fixed mold (dry-bag).

Isostatic pressing may be either hot isostatic pressing or cold isostatic pressing. Hot isostatic pressing (HIP) compresses and sinters the part simultaneously by applying heat ranging from 480° C. to 1230° C. Hot isostatic pressing (HIP) typically uses gas pressure to provide compaction. Argon (Ar) gas is the most common gas used in hot isostatic pressing (HIP) because it is an inert gas, thus prevents chemical reactions during the operation. Cold isostatic pressing (CIP) uses fluid as a means of applying pressure to the mold at room temperature, e.g., 20° C. to 25° C. Following cold isostatic pressing, the green product typically is sintered in a separate apparatus, such as a furnace.

In yet another embodiment, compaction may be provided by roll forming, which may also be referred to as roll compaction. In roll forming, the powder, i.e., titanium-containing powder and carbon powder, are fed into two counter rotating rollers, and are compacted into a strip. The frictional forces of the powder against the roller helps to facilitate a constant flow rate, while compressive stresses between the rollers consolidate the material into a continuous green sheet. The strip may then be sintered in a manner that is similar to the sintering process that is described above with reference to powder pressing.

The above-described powder metallurgy forming processes typically provides a composite of carbon and titanium and/or titanium alloy having a net shape with dimensions within 95% or greater than the final shape of the product. In some embodiments, the above-described powder metallurgy processes provides a composite of carbon and titanium and/or titanium alloy having a net shape having dimensions within 99% or greater than the fmal shape of the product. Optional secondary processing of the composite of the carbon and titanium and/or titanium alloy may include machining, such as computer numerical control (CNC) machining, of the composite to the final desired dimensions. Other secondary processes that may be applied to the composite of the carbon and titanium and/or titanium alloy include plating and heat treatments.

Following sintering, the composite structure of the carbon and the titanium and/or titanium alloy may have a compressive strength of 2 MPa or greater. In another embodiment, the composite structure of the carbon and the titanium and/or titanium alloy may have a compressive strength of 3 MPa or greater. In another embodiment, the composite structure of the carbon and the titanium and/or titanium alloy may have a compressive strength of 5 MPa or greater.

The composite structure of the carbon and the titanium and/or titanium alloy typically maintains the surface area of the carbon powder. In one embodiment, the composite structure of the carbon and the titanium and/or titanium alloy has a surface area ranging from 300 m²/g to 3,000 m²/g. In another embodiment, the composite structure of the carbon and the titanium and/or titanium alloy has a surface area of the activated carbon may from 1,000 m²/g to 2,000 m²/g.

The composite structure of the carbon and the titanium and/or titanium alloy is resistant to corrosive attack by salt water, or marine environments. It also exhibits good resistance to a wide range of acids, alkalis and industrial chemicals. For example, the composite structure of the carbon and the titanium and/or titanium alloy has a corrosion of less than 0.03 mm/yr in response to a 30 day exposure of sea water, wherein the seawater contacts the sample at a rate of 90 knots with a 45 degree impingement angle. In another example, the composite structure of the carbon and the titanium and/or titanium alloy has a corrosion of less than 0.025 mm/yr in response to a 30 day exposure of sea water, wherein the seawater contacts the sample at a rate of 90 knots with a 45 degree impingement angle.

The composite of the carbon and titanium and/or titanium alloy may be useful for a variety of applications, particularly as capacitive deionization (CDT) electrode materials. Other applications include, for example, gas separation, chromatography, catalysis (e.g., as a support or active material), electrode materials (e.g., in batteries), and supercapacitors.

In one embodiment, a device for capacitive deionization is provided that includes at least two porous electrodes 35a , 35b , wherein each of the two porous electrodes 35a , 35b is comprised of a carbon and titanium and/or titanium alloy composite, as depicted in FIG. 2. The at least two porous electrodes 35a , 35b may be provided by the composite that is described above, in which carbon provides the dispersed phase of the composite and the titanium provides the matrix phase of the composite. The carbon component of the composite provides the adsorption site for capacitive deionization. The porosity provided by the carbon provides a surface area ranging from 300 m²/g to 3,000 m²/g. In another embodiment, each of the least two porous electrodes 35a , 35b provided by the composite of the carbon and the titanium and/or titanium alloy has a surface area of the activated carbon that ranges from 1,000 m²/g to 2,000 m²/g. The at least two porous electrodes 35a , 35b are spaced from one another by a dimension suitable to provide a passageway through the least two porous electrodes 35a , 35b so that an electrolyte stream 40 makes contact with the electrodes 35a , 35b.

As used herein, the term “electrolyte stream” is any substance containing free ions in a solvent that make the mixture of the solvent and ions electrically conductive. Commonly, electrolytes are solutions of acids, bases or salts. Electrolyte solutions are normally formed when a salt is placed into a solvent, such as water, and the individual components dissociate due to the thermodynamic interactions between solvent and solute molecules. In one embodiment, the electrolyte stream may be provided by sea water. One example of sea water that may be employed as an electrolyte stream in accordance with the present disclosure has a composition including less than 90% oxygen (O), less than 15% hydrogen (H), less than 2% chlorine (Cl), less than 1.5% sodium (Na), less than 0.15% magnesium (Mg), less than 0.1% sulfur (S), less than 0.05% calcium (Ca), less than 0.05% potassium (K), less than 0.0075% bromine (Br), and less than 0.005% carbon (C). The electrolyte stream may be provided by a flow through system, or a static system.

Still referring to FIG. 2, in one embodiment, a voltage source 45 is in electrical communication to each of the at least two porous electrodes 35a , 35b . The voltage source 45 may be a direct current (DC) voltage source for producing a bias across the opposing electrodes of the at least two electrodes 35a , 35b . The voltage source 45 may be a battery or a rectifier. The porous electrode 35a that provides the anode may be connected to the positive terminal of the power supply 45, and the porous electrode 35b that provides the cathode may be connected to the negative terminal. The device for capacitive deionization that is depicted in FIG. 2 may include a membrane 50a , 50b on the opposing electrodes 35a , 35b . In one embodiment, the membrane may be composed of any material that may collect the salts and minerals from water being removed during the desalination of water. In one embodiment, the membrane 50a , 50b may be composed of porous polyethylene. The membrane 50a , 50b is optional and may be omitted. The device depicted in FIG. 2 may further include a passageway to bring the electrolyte through the at least two porous electrodes so that an electrolyte stream makes contact with the electrodes. In one embodiment, the passageway may be provided by a series of pipes, such as insulating polymeric pipes. The device depicted in FIG. 2 may also be applied in a cartridge form which is inserted into a static electrolyte stream or a pipe through with the electrolyte stream is being traversed.

In one embodiment, the structure depicted in FIG. 2 may be employed in a method of capacitive deionization. Capacitive deionization is a technology for desalination and water treatment in which salts and minerals are removed from water, e.g., an electrolyte stream, by applying an electric field between the at least two electrodes 35a , 35b . The method of capacitive deionization may begin with providing at least two porous electrodes 35a , 35b , wherein each of the two porous electrodes 35a , 35b is comprised of a carbon and titanium composite. The at least two porous electrodes are spaced in a manner so that a passageway for an electrolyte stream 40 to make contact with each of the at least two porous electrodes 35a , 35b . The electrolyte stream 40 is passed through the passageway into contact with the two porous electrodes 35a , 35b while a bias is applied across the two porous electrodes 35a , 35b.

Cations and anions within the electrolyte stream are attracted to an oppositely charged surface of the two porous electrodes, wherein the cations 36 and anions 37 are removed from the electrolyte stream 40 by adsorption to the oppositely charged surface of the two porous electrodes 35a , 35b . More specifically, counterions, i.e., ions having opposite charge as the anode or cathode, are stored in the electrical double layers which form at the solution interface inside the porous electrodes 35a , 35b , with the ions of cations 36 stored in the negatively charged electrode 35a (cathode), and anions 37 stored in the positively charged electrode 35b (anode). In one embodiment, the method includes applying an electrical potential difference between the two electrodes 35a , 35b on the order of 0.5 V to 1.5 V, anions 36 are absorbed into the anode and cations 37 into the cathode, thereby producing a (partially) ion-depleted product stream. In one embodiment, the cations 36 are provided by sodium ions (Na⁺) and the anions 37 are provided by chlorine (Cl⁻) ions.

The following examples are provided to further illustrate some embodiments of the present disclosure and to demonstrate some advantages that arise therefrom. It is not intended that the present disclosure be limited to the specific examples disclosed.

Ti-6Al-4V powders were screened through a −40 mesh, and mixed with activated carbon having a particle size of approximately 100 microns. The mixture included 75% Ti-6Al-4V powder, and 25% activated carbon. The 75/25 mixture of Ti-6Al-4V powder and activated carbon powder was then placed in a vacuum hot press and pressed at a temperature of 950° C. FIG. 3 depicts a composite of Ti-6Al-4V and activated carbon formed from a 75/25 mixture of Ti-6Al-4V powder and activated carbon powder. The composite depicted in FIG. 3 had a disk geometry. The electrical conductivity of the sample depicted in FIG. 3 was measured and the conductivity was typical of a conductor, such as copper. Composites of Ti-6Al-4V and activated carbon were also formed from a 60/40 mixture of Ti-6Al-4V powder and activated carbon powder.

### Measurement of Surface Porosity of Composite of Ti-6Al-4V and Activated Carbon

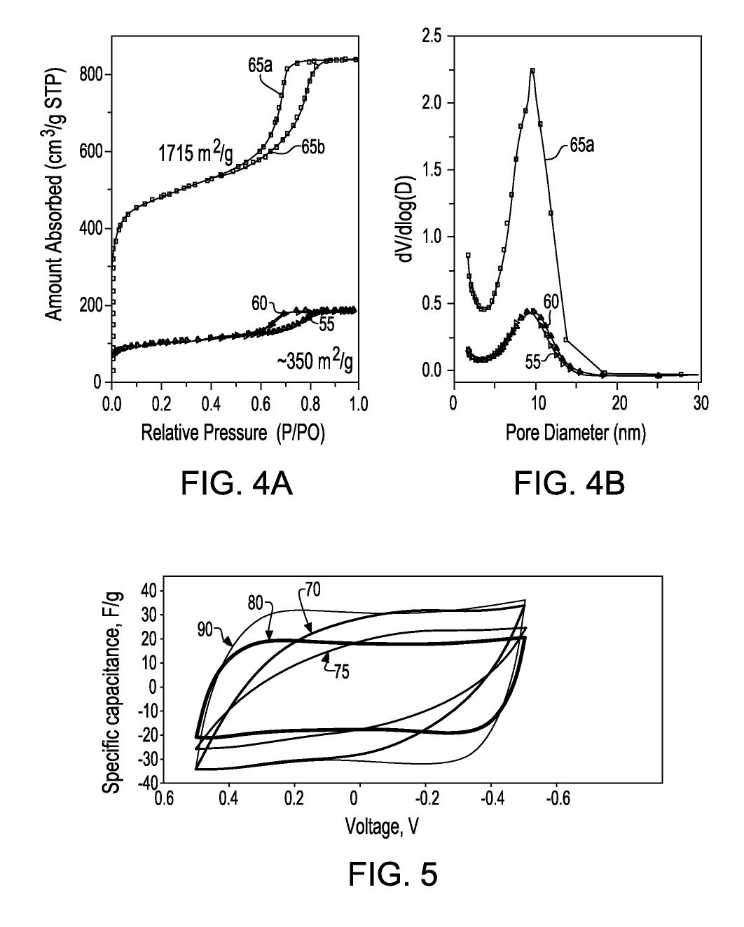

The composite of Ti-6Al-4V and activated carbon formed from the 75/25 mixture of Ti-6Al-4V powder and activated carbon powder depicted in FIG. 3 was characterized using BET surface characterization. Similarly, the composite of Ti-6Al-4V and activated carbon formed from the 60/40 mixture of Ti-6Al-4V and activated carbon was characterized using BET surface characterization. A comparative sample of 200 micron activated mesoporous carbon was also characterized using BET surface characterization. The results of the gas-adsorption characterization are depicted in FIGS. 4A and 4B.

FIG. 4A is a plot of BET surface characterization of a composite of Ti-6Al-4V and activated carbon wherein the y-axis represents absorption (cm³/g) and the x-axis is the relative pressure (P/P0). FIG. 4B is a plot of BET surface characterization of a composite of Ti-6Al-4V and activated carbon wherein the y-axis represents and the x-axis is the pore size (nm). In FIGS. 4A and 4B, the plot identifed by reference number 55 represents the BET surface characterization from the composite of Ti-6Al-4V and activated carbon that was formed from the 75/25 (25 wt % carbon) mixture of Ti-6Al-4V powder and activated carbon powder. The plot identifed by reference number 60 represents the BET surface characterization from the composite of Ti-6Al-4V and activated carbon that was formed from the 60/40 mixture (40 wt % carbon) of Ti-6Al-4V powder and activated carbon powder. The plot identified by reference number 65a , 65b represents the BET surface characterization from the comparative sample of 200 micron activated mesoporous carbon.

The results plotted in FIGS. 4A and 4B indicate that the pores of the carbon material are accessible after forming the composites of Ti-6Al-4V and activated carbon. Measured values of BET specific surface area (by nitrogen adsorption) for composite materials formed using carbon having a specific surface area of 1700 m²/g were approximately 350 m²/g for composites of Ti-6Al-4V and activated carbon containing both 25 wt % carbon and 40 wt % carbon.

### Cyclic Voltammetry of the Titanium/Mesoporous Carbon

FIG. 5 is a plot of the cyclic voltammetry results for a composite of Ti-6Al-4V and activated carbon that was formed from the 60/40 mixture (40 wt % carbon) of Ti-6Al-4V powder and activated carbon powder, in which the cyclic voltammetry was conducted in aqueous solutions relevant to applications of capacitive deionization for water treatment. The y-axis represents specific capacitance in farads per gram (F/g) and the x-axis represents voltage. The cyclic voltammetry results were measured at a scanning rate of 10 milli-volts per second (mV/sec). The plot identified by reference number 70 identifies the specific capacitance measured from a composite of Ti-6Al-4V and activated carbon in a 1 molar sodium chloride (NaCl) solution. The plot identified by reference number 75 identifies the specific capacitance measured from the composite of Ti-6Al-4V and activated carbon in a 0.1 molar sodium chloride (NaCl) solution. The plot identified by reference number 80 identifies the specific capacitance measured from the composite of Ti-6Al-4V and activated carbon in a 1 molar calcium chloride (CaCl₂) solution. The plot identified by reference number 80 identifies the specific capacitance measured from the composite of Ti-6Al-4V and activated carbon in a 0.1 molar calcium chloride (CaCl₂) solution.

The results depicted in FIG. 5 indicate excellent retention of accessible pore area of carbon in the composite of Ti-6Al-4V and activated carbon. For example, the measured value of 30 F/g specific capacitance is on the order of 30-38% of the value for the original carbon powder, while the carbon comprises 40% of the weight of the composite of Ti-6Al-4V and activated carbon. The results demonstrate that the composite material could act as a self-supporting, conductive electrode type material with electrically connected active carbon with accessible pores for use in capacitive storage of ions, such as in the separation of dissolved salts for water treatment.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed:

1. A method of forming a composite structure comprising:
mixing a titanium-containing powder with carbon powder; and
forming the mixture of the titanium-containing powder and carbon powder into the composite structure at a temperature of less than 1500° C., wherein the titanium-containing powder provides a matrix phase of the composite and the carbon powder provides the dispersed phase of the composite, wherein the forming process provides a net shape having dimensions within 95% or greater than the final shape of the product.

2. The method of claim 1, wherein the composite structure has a compressive strength greater than 3 MPa.

3. The method of claim 1, wherein a concentration of the carbon-containing powder in the composite ranges from 5% to 75% of the composite structure.

4. The method of claim 1, wherein a concentration of the titanium-containing power in the composite ranges from 25% to 95% of the composite structure.

5. The method of claim 1, wherein the titanium-containing powder comprises less than 0.2% iron (Fe), less than 0.18% oxygen (0), less than 0.1% carbon, less than 0.03% nitrogen (N) and less than 0.0125% hydrogen (H) and substantially a remainder of titanium (Ti).

6. The method of claim 1, wherein the titanium-containing power comprises 5.5% to 6.5% aluminum (Al), 3.5% to 4.5% vanadium (V), less than 0.1% carbon, less than 0.3% iron (Fe), less than 0.2% oxygen (O), less than 0.05% nitrogen (N) and less than 0.015% hydrogen (H) and substantially a remainder of titanium (Ti).

7. The method of claim 1, wherein the titanium-containing powder is formed by reduction of titanium chloride (TiCl₄) with liquid sodium (Na).

8. The method of claim 1, wherein the titanium-containing powder is formed by magnesium (Mg) reduction in titanium chloride (TiCl₄).

9. The method of claim 1, wherein the carbon powder has a particle size with a diameter ranging from 15 μm to 200 μm.

10. The method of claim 1, wherein the carbon powder has a pore size ranging from 5 A to 100 nm.

11. The method of claim 1, wherein the forming of the mixture of the titanium-containing powder and carbon powder into the composite structure comprises vacuum hot pressing (VHP), extrusion, roll compaction, powder pressing, hot isostatic pressing, cold isostatic pressing, sintering or a combination thereof.

12. The method of claim 1, wherein the compact material is a formed into an electrode from capacitive deionization (CDI), capacitors, batteries or gas separation.

13. A structure for capacitive deionization comprising:
at least two porous electrodes comprised of a carbon and titanium composite, wherein the carbon provides the dispersed phase of the composite and the titanium provides the matrix phase of the composite;
a passageway through the least two porous electrodes so that an electrolyte stream makes contact with the electrodes; and
a voltage source in electrical communication to the at least two porous electrodes.

14. The structure of claim 13, wherein the carbon and titanium composite that provides the at least two porous electrodes has a compressive strength greater than 3 MPa.

15. The structure of claim 13, wherein a concentration of the carbon in the carbon and titanium composite ranges from 5% to 75% of the composite structure.

16. The structure of claim 13, wherein a concentration of the titanium in the carbon and titanium composite ranges from 25% to 95% of the composite structure.

17. The structure of claim 13, wherein the matrix phase of the carbon and titanium composite comprises less than 0.5% iron (Fe), less than 0.4% oxygen (O), less than 0.1% carbon, less than 0.05% nitrogen (N) and less than 0.0125% hydrogen (H) and substantially a remainder of titanium (Ti).

18. The structure of claim 13, wherein the dispersed phase of the carbon and titanium composite comprises carbon having a particle size with a diameter ranging from 15 μm to 200 μm, and a pore size ranging from 5 A to 100 nm.

19. The structure of claim 13, wherein the passageway through the least two porous electrodes further comprises membrane positioned between the electrolyte stream makes and the electrodes.

20. The structure of claim 13, wherein the voltage source is a direct current (DC) voltage source for producing a bias across the opposing electrodes of the at least two electrodes.

21. A method of capacitive deionization comprising:
providing at least two porous electrodes that are positioned to be contacted by an electrolyte stream flowing through a passageway, wherein the at least two porous electrodes are comprised of a carbon and titanium composite in which the carbon provides a dispersed phase of the composite and the titanium provides a matrix phase of the composite;
flowing the electrolyte stream through the passageway into contact with the two porous electrodes; and
applying a bias across the two porous electrodes, wherein cations and anions within the electrolyte stream are attracted to an oppositely charged surface of the two porous electrodes, wherein the cations and anions are removed from the electrolyte stream by adsorption to the oppositely charged surface of the two porous electrodes.

22. The method of claim 21, wherein the carbon and titanium composite that provides the at least two porous electrodes has a compressive strength greater than 3 MPa.

23. The method of claim 21, wherein a concentration of the carbon in the carbon and titanium composite ranges from 5% to 75% of the composite structure.

24. The method of claim 21, wherein the matrix phase of the carbon and titanium composite comprises less than 0.5% iron (Fe), less than 0.4% oxygen (0), less than 0.1% carbon, less than 0.05% nitrogen (N) and less than 0.0125% hydrogen (H) and substantially a remainder of titanium (Ti).

25. The method of claim 21, wherein the dispersed phase of the carbon and titanium composite comprises carbon having a particle size with a diameter ranging from 15 μm to 200 μm, and a pore size ranging from 5 Å to 100 nm.

26. The method of claim 21, wherein the electrolyte stream is an aqueous solution comprising less than 90% oxygen (0), less than15% hydrogen (H), less than 2% chlorine (Cl), less than 1.5% sodium (Na), less than 0.15% magnesium (Mg), less than 0.1% sulfur (S), less than 0.05% calcium (Ca), less than 0.05% potassium (K), less than 0.0075% bromine (Br), and less than 0.005% carbon.

27. The method of claim 21, wherein the applying of the bias comprises a potential difference between the two porous electrodes ranging from 0.5 V to 1.5 V.
